(19) United States
(12) Patent Application Publication
(10) Pub. No.: US 2008/0287170 A1
(43) Pub. Date: Nov. 20, 2008

(54) WIRELESS COMMUNICATION APPARATUS

(75) Inventors: Cheng-Wen Huang, Taipei County (TW); Chung-Tsung Wang, Taipei County (TW)

Correspondence Address: J C PATENTS, INC., 4 VENTURE, SUITE 250, IRVINE, CA, 92618, US

(73) Assignees: GIGA-BYTE COMMUNICATIONS INC., Taipei County (TW); GIGA-BYTE TECHNOLOGY CO., LTD., Taipei Hsien (TW)

(21) Appl. No.: 11/748,131

(22) Filed: May 14, 2007

(51) Int. Cl. H04M 1/00

(52) U.S. Cl. 455/575.7

(57) ABSTRACT

A wireless communication apparatus is provided. The wireless communication apparatus includes a transceiver and a hanging decoration. The transceiver includes an antenna having a metal area exposed to air. The transceiver receives or transmits electromagnetic signal through the antenna. The hanging decoration is disposed on the wireless communication apparatus and includes a metal conductor. When the antenna is connected to the metal area through the metal conductor, the frequency range of the antenna for transmitting or receiving the electromagnetic signal is changed. Therefore, the communication ability of the wireless communication apparatus is improved.

### BACKGROUND OF THE INVENTION

1. Field of the Invention

The present invention generally relates to a wireless communication apparatus, more particularly, to a wireless communication apparatus with a hanging decoration capable of improving communication ability.

2. Description of Related Art

With the progress and acceptance of communication techniques, mobile phone has become an indispensable and principle communication equipment in our life. At present, the number of mobile phone users even exceeds the number of home phone users. Because of enormous business opportunity in the mobile phone market, every manufacturer is producing all kinds of mobile phone related accessories, for example: mobile phone casing, mobile phone hanging decorations and so on.

It should be noted that the only function of most of the mobile phone hanging decorations in the market is to adorn the mobile phone and make it more eye-catching. For example, mobile phone hanging decorations are mainly model figures. However, as time changes, consumers are no longer satisfied with hanging decorations that only have an adornment and eye-catching function. Therefore, every manufacturer is trying hard to design a series of mobile phone hanging decorations having supplementary functions. For example, some mobile phone hanging decorations have the function of brightening up on receiving an incoming call, some mobile phone hanging decorations have the function of shielding the consumers against radiation, some mobile phone hanging decorations have the function of emitting sound on receiving an incoming call and some mobile phone hanging decorations have the function of rotating a model figure on receiving an incoming call. In reality, consumers admire mobile phone hanging decorations having supplementary functions more.

Accordingly, if mobile hanging decorations having other supplementary function can somehow be developed, it is a good news not only for consumers but also for the manufacturers because of the business opportunity that can be opened up.

### SUMMARY OF THE INVENTION

Accordingly, the present invention is directed to a wireless communication apparatus for enhancing the communication ability of wireless communication.

According to an embodiment of the present invention, a wireless communication apparatus is provided. The wireless communication apparatus includes a transceiver and a hanging decoration. The transceiver includes an antenna having a metal area exposed to air. The transceiver receives or transmits an electromagnetic signal through the antenna. The hanging decoration is disposed on the wireless communication apparatus and includes a metal conductor. When the antenna is connected to the metal area through the metal conductor, the frequency range of the electromagnetic signal transmitted or received by the antenna is changed.

In an embodiment of the present invention, the metal conductor includes an extension part and a body part. The extension part is exposed to air and is connected to the metal area. An outer insulating layer covers the surface of the body part. In another embodiment, the extension part is a latching hook, a magnet or a clip. Furthermore, the shape of the body part includes linear shape, ring shape or U-shape.

In an embodiment of the present invention, the hanging decoration includes a base and a connecting element. The base has a first layer and a second layer. The first layer is connected to the outer insulating layer. The connecting element is connected to the second layer for fixing the hanging decoration to a hanging decoration hole of the wireless communication apparatus. The connecting element includes a hanging cord or a hooking ring.

In an embodiment of the present invention, the hanging decoration includes a connecting element. The connecting element is connected to the outer insulating layer for fixing the hanging decoration to a hanging decoration hole of the wireless communication apparatus. It should be noted that the connecting element could be a hanging cord or a hooking ring. Furthermore, the transceiver is a mobile phone, a walkie-talkie, a digital mobile assistant or a portable television. More specifically, when the metal conductor is connected to the metal area, the antenna is capable of receiving or transmitting the electromagnetic signal at a wireless communication frequency range between 30 MHz˜300 MHz or 300 MHz˜3 GHz.

In an embodiment of the present invention, the wireless communication apparatus further includes an outer casing. The outer casing encapsulates the transceiver. The outer casing has at least one keypad or navigational key for operating the wireless communication apparatus. In another embodiment, the wireless communication apparatus further includes a screen. The screen is coupled to the transceiver for outputting messages provided by the transceiver.

The wireless communication apparatus of the present invention includes a transceiver and a hanging decoration. The transceiver has an antenna with a metal area exposed to air. When the antenna is connected to the metal area through the metal conductor, the frequency range of the electromagnetic signal transmitted or received by the antenna is changed.

In order to make the aforementioned and other objects, features and advantages of the present invention comprehensible, preferred embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a wireless communication apparatus according to an embodiment of the present invention.

FIGS. 2A˜2D are diagrams showing the shapes of body parts and outer insulating layers of hanging decorations according to an embodiment of the present invention.

FIG. 3 is a diagram showing a connecting element according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

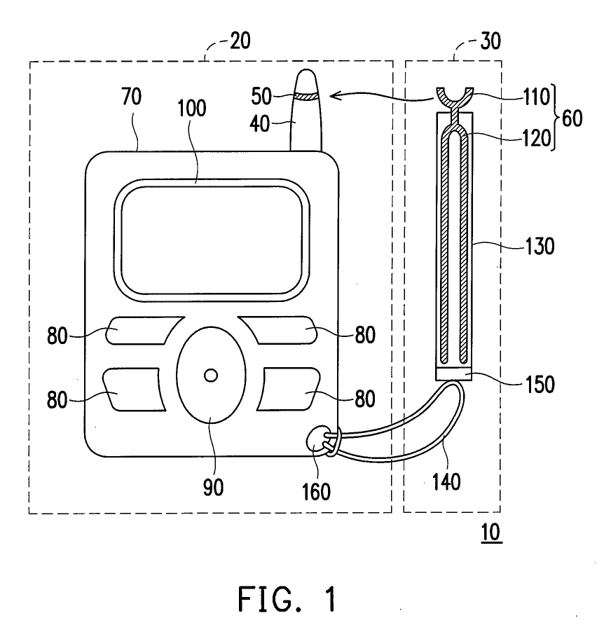

FIG. 1 is a diagram of a wireless communication apparatus according to an embodiment of the present invention. As shown in FIG. 1, the wireless communication apparatus 10 includes a transceiver 20 and a hanging decoration 30. The transceiver 20 has an antenna 40 and the antenna 40 exposes a metal area 50 to air. The transceiver 20 can receive or transmit an electromagnetic signal in the air through the antenna 40. More specifically, the transceiver 20 can communicate with a remote base station (or a server end) through the electromagnetic signal received or transmitted by the antenna 40.

The hanging decoration 30 is disposed on the wireless communication apparatus 10 and includes a metal conductor 60. When the metal conductor 60 is connected to the metal area 50, the antenna 40 and the metal conductor 60 together can be regarded as another antenna. For example, when the metal area 50 of the antenna 40 is connected to an extension part 110 of the hanging decoration 30, the frequency range of the wireless communication apparatus 10 for receiving and transmitting electromagnetic signal is changed to Very High Frequency (VHF) or Ultra High Frequency (UHF). The frequency range of the VHF is between 30 MHz˜300 MHz and the frequency range of the UHF is between 300 MHz˜3 GHz.

It should be noted that although the foregoing embodiment has already described one possible configuration of the wireless communication apparatus 10, anyone skilled in the art may understand that each manufacturer may design the wireless communication apparatus 10 differently. Therefore, the application of the present invention should not be limited only to this one possible configuration. In other words, any design that changes the communication ability of a wireless communication apparatus 10 through a connection between the metal area 50 of an antenna 40 and a metal conductor 40 of the hanging decoration 30 is within the spirit of the present invention. To clarify the spirit of the present invention, one specific embodiment of the present invention is provided as an example in the following.

### Second Embodiment

As shown in FIG. 1, the wireless communication apparatus 10 of the present embodiment is a mobile phone, for example. The wireless communication apparatus 10 includes a transceiver 20 and a hanging decoration 30. The transceiver 20 has an antenna 40 and the antenna 40 exposes a metal area 50 to air. The transceiver 20 is an integrated circuit device having communication ability, for example. Furthermore, anyone skilled in the art can design an outer casing 70 that encapsulates and protects the transceiver 20. The outer casing 70 has four keypads 80 and a navigation key 90 for operating the wireless communication apparatus 10. In other embodiment, anyone skilled in the art may design the outer casing 70 with different number of keypads 90, navigation keys or other control devices for operating the wireless communication apparatus 10. In addition, anyone skilled in the art may design a screen 100 coupled to the transceiver 20 for displaying messages produced by the transceiver 20.

The metal conductor 60 of the hanging decoration 30 includes an extension part 110 and a body 120. The extension part 110 is exposed to air and the hanging decoration 30 is connected to the metal area 50 through the extension part 110. For example, the extension part 110 is a metallic latching hook, a magnet or a clip. In the present embodiment, the body part 120 and the extension part 110 are electrically connected. The body part 120 is also a good conductor made of metal for expanding the reception capacity of the antenna.

From another point of view, the antenna 40 and the metal conductor 60 together can be regarded as another antenna (renamed an antenna 41) when the metal area 50 of the antenna 40 is connected to the extension part 110 of the hanging decoration 30. Therefore, the frequency range of the wireless communication apparatus 10 for receiving and transmitting electromagnetic signal is changed. For example, the antenna 40 of the wireless communication apparatus 10 originally receives and transmits the electromagnetic signal at a frequency of about 800 MHz. When the metal area 50 of the antenna 40 is connected to the extension part 110 of the handing decoration 30 to form the antenna 41, the frequency range of the wireless communication apparatus 10 for receiving and transmitting electromagnetic signal is changed to between 470 MHz˜770 MHz. Consequently, the wireless communication apparatus 10 can receive the electromagnetic signal of color television broadcast standard and digital television broadcast laid down by National Television System Committee (NTSC). Moreover, anyone skilled in the art can dispose a number of different hanging decorations 30 on the wireless communication apparatus 10 so that a different hanging decoration can be selected to change the frequency range of the wireless communication apparatus 10 for receiving and transmitting the electromagnetic signal.

As shown in FIG. 1, anyone skilled in the art may design an outer insulating layer 130 to cover the surface of the body part 120 so as to prevent any interference of the electromagnetic signal. For example, a hanging decoration 30 having an outer insulating layer 130 can prevent the body of a user from contacting the body part 120 and lead to the interference of the electromagnetic signal. In addition, the extension art 110 and the body part 120 of the hanging decoration 30 can be made using an elastic metallic material to prevent the user from being hurt by accidental collision. Furthermore, a bearing or a spindle axis can be disposed between the extension part 110 and the body part 120. The bearing or spindle axis allows the hanging decoration 30 to rotate so that the electromagnetic signal coming from different directions can be received as long as electrical connection between the extension part 110 and the body part 120 are maintained all the time.

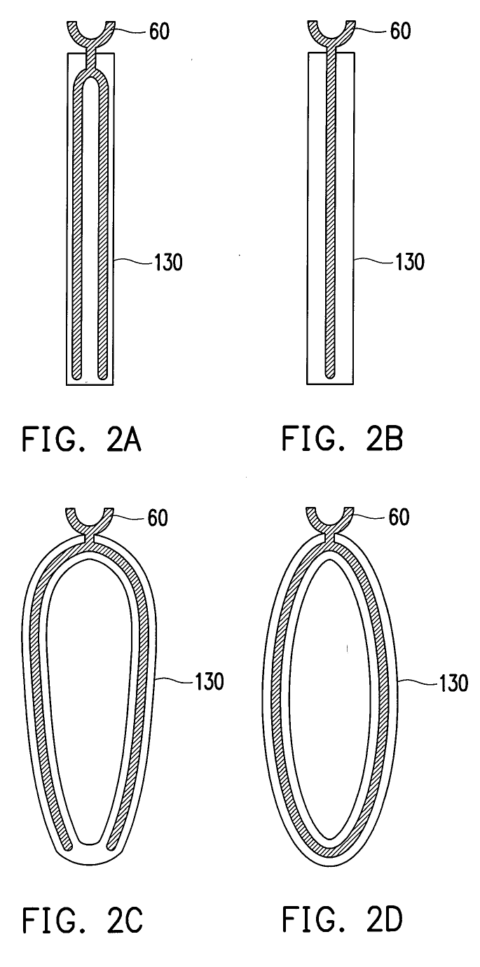

Those skilled in the art should know that the shape of the antenna of the wireless communication apparatus is closely relate to the ability of the antenna for receiving and transmitting the electromagnetic signal as well as the frequency range of the electromagnetic signal. Therefore, anyone skilled in the art may change the shape of the body part 120 and suitably modify the outer insulating layer 130 in the foregoing embodiment in order to meet a specific requirement. FIGS. 2A˜2D are diagrams showing the shapes of body parts and outer insulating layers of hanging decorations according to an embodiment of the present invention. The body part 120 in FIG. 2A is modified to a long and narrow U-shape and the outer insulating layer 130 has a linear shape. The body part 120 in FIG. 2B is modified to a linear shape and the outer insulating layer 130 also has a linear shape. The body part 120 in FIG. 2C is modified to a wider U-shape and the outer insulating layer 130 has an oval shape. The body part 120 in FIG. 2D is modified to a ring shape and the outer insulating layer 130 also has an oval shape.

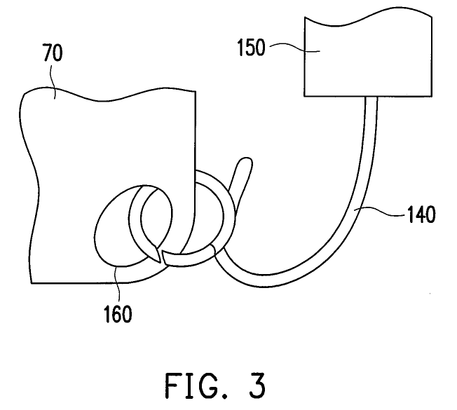

FIG. 3 is a diagram showing a connecting element according to an embodiment of the present invention. As shown in FIGS. 1 and 3, the hanging decoration 30 is normally fixed to a hanging decoration hole 160 of the transceiver 20 through a connecting element 140. The most common connecting element 140 includes, for example, the hanging cord as shown in FIG. 1 or a hooking ring (alternatively called an question-mark hook) as shown in FIG. 3. In the meantime, another part of the connecting element 140 is fixed onto the outer insulating layer 130 of the hanging decoration 30. In other embodiment, anyone skilled in the art may design a base 150 between the connecting element 140 and the outer insulating layer 130. A first layer of the base 150 is connected to the outer insulating layer 130 and a second layer of the base 150 is connected to the connecting element 140 so as to strengthen the firmness of attachment to the hanging decoration 30.

It should be noted that the wireless communication apparatus in the second embodiment also uses a mobile phone as an example for describing the method of implementation. Anyone skilled in the art should notice that the example of a ‘mobile phone’ used in the second embodiment is only a specific embodiment. In another embodiment, the wireless communication apparatus can be a walkie-talkie, a digital mobile assistant or a portable television and so on. Therefore, the present invention is not limited to the aforementioned specific embodiments.

In summary, the wireless communication apparatus of the present invention changes the frequency range of the antenna for receiving and transmitting the electromagnetic signal through the connection between the metal area of the antenna and the metal conductor of the metal conductor. In addition, the embodiments of the present invention include at least the following advantages:

1. The communication ability of the wireless communication apparatus is enhanced so that the wireless communication apparatus can be used as a voice communication tool as well as a tool for receiving television broadcasting signal or a tool for listening to broadcast and so on.

2. By changing the shape of the metal area of the hanging decoration, the communication ability of the wireless communication apparatus can be enhanced in many different ways.

3. The metal conductor of the hanging decoration can be easily connected to the metal area of the antenna through the extension part of the hanging decoration.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wireless communication apparatus, comprising:
a transceiver, having an antenna and the antenna having a metal area exposed to air, wherein, the transceiver receives or transmits an electromagnetic signal in the air through the antenna; and
a hanging decoration, disposed on the wireless communication apparatus and comprising a metal conductor,
wherein, the antenna is electrically connected to the metal area through the metal conductor so as to change its frequency range for receiving or transmitting electromagnetic signal.

2. The wireless communication apparatus according to claim 1, wherein the metal conductor comprises:
an extension part, exposed to air and connected to the metal area; and
a body part, electrically connected to the extension part and its surface covered with an outer insulating layer.

3. The wireless communication apparatus according to claim 2, wherein the extension part comprises a metallic latching hook, a magnet or a clip.

4. The wireless communication apparatus according to claim 2, wherein the shape of body part comprises a linear shape, a circular shape or a U-shape.

5. The wireless communication apparatus according to claim 2, wherein the hanging decoration comprises:
a base, having a first layer and a second layer, wherein the first layer is connected to the outer insulating layer; and
a connecting element, connected to the second layer for fixing the hanging decoration to a hanging decoration hole of the wireless communication apparatus.

6. The wireless communication apparatus according to claim 5, wherein the connecting element comprises a hanging cord and a hooking ring.

7. The wireless communication apparatus according to claim 2, wherein the hanging decoration further comprises:
a connecting element, connected to the outer insulating layer for fixing the hanging decoration to a hanging decoration hole of the wireless communication apparatus.

8. The wireless communication apparatus according to claim 7, wherein the connecting element comprises a hanging cord or a hooking ring.

9. The wireless communication apparatus according to claim 1, wherein the transceiver comprises a mobile phone, a walkie-talkie, a digital mobile assistant or a portable television.

10. The wireless communication apparatus according to claim 1, wherein the frequency range of the antenna for receiving and transmitting electromagnetic signal is between 30 MHz˜300 MHz or between 300 MHz ˜3 GHz when the metal conductor is connected to the metal area.

11. The wireless communication apparatus according to claim 1, further comprising:
an outer casing, encapsulating the transceiver and having at least one keypad or navigation key for operating the wireless communication apparatus.

12. The wireless communication apparatus according to claim 1, further comprising a screen, coupled to the transceiver for displaying any message produced by the transceiver.
